(19) United States
(12) Patent Application Publication
(10) Pub. No.: US 2026/0197715 A1
(43) Pub. Date: Jul. 9, 2026

(54) CONTROL NODE FOR MOBILE COMMUNICATION NETWORK AND COMPUTER READABLE STORAGE MEDIUM

(71) Applicant: KDDI CORPORATION, Tokyo (JP)

(72) Inventor: Akio IKAMI, Fujimino-shi (JP)

(21) Appl. No.: 19/555,564

(22) Filed: Mar. 3, 2026

Related U.S. Application Data
(63) Continuation of application No. PCT/JP2024/007231, filed on Feb. 28, 2024.

(30) Foreign Application Priority Data
Sep. 26, 2023 (JP) 2023-163024

(51) Int. Cl. H04W 28/22

(52) U.S. Cl. CPC H04W 28/22

(57) ABSTRACT

A control node includes: a collection unit configured to collect rate information and number information of a wireless device, wherein the rate information of the wireless device indicates a transmission rate between a unit associated with the wireless device and one of the one or more access points associated with the wireless device, and the number information of the wireless device indicates a number of the one or more access points, and a determination unit configured to determine, in a manner satisfying constraint conditions, whether to implement the unit on a first computer group or the second computer group, wherein the constraint conditions include a first condition that is satisfied when a total transmission rate of signals transmitted over a transmission path for communication with one or more wireless devices does not exceed a maximum transmission rate.

### CROSS-REFERENCE TO RELATED APPLICATIONS

This application is a continuation of International Patent Application No. PCT/JP2024/007231 filed on February 28, 2024, which claims priority to and the benefit of Japanese Patent Application No. 2023-163024 filed on September 26, 2023, the entire disclosures of which are incorporated herein by reference.

### BACKGROUND OF THE INVENTION

### Field of the Invention

The present disclosure relates to a control technique for a radio access network (RAN) of a mobile communication network.

### Description of the Related Art

A RAN of a mobile communication network is composed of a Central Unit or Centralized Unit (CU), a Distributed Unit (DU), and a Radio Unit (RU) and the like. The RU has a function to transmit and receive radio signals with a Wireless Device (WD). The DU performs processing such as that of a Medium Access Control (MAC) layer, a Radio Link Control (RLC) layer and the like. The CU performs processing of higher layers than those processed by the DU, such as a Packet Data Convergence Protocol (PDCP) layer and the like.

To cover a geographic area served by the mobile communication network, RUs are deployed in a distributed manner within the geographic area. On the other hand, DUs and CUs are deployed in a smaller number of communication sites than the RUs. Generally, communication sites are classified into “edge sites,” which accommodate a plurality of RUs deployed in a geographically distributed manner, and “central sites,” which accommodate a plurality of edge sites. PTL 1 discloses various placement patterns of the DUs and CUs to edge sites and central sites.

Also, PTL 2 discloses a coherent interference suppression technique called cell-free massive MIMO (CF-mMIMO) technique. In CF-mMIMO, the function of transmitting and receiving radio signals with a WD, which corresponds to the RU described above, is referred to as an Access Point (AP). Therefore, in the following description, the term AP is used instead of RU. CF-mMIMO is a communication technique that performs MIMO communication using a plurality of APs for communication with a single WD. In CF-mMIMO, one or more APs used for communication with a single WD are selected. The set of one or more APs used for communication with a single WD is referred to as a “cluster” associated with the WD or the WD’s “cluster.”

In the downlink direction, the DU generates signals to be transmitted to each AP in the cluster associated with the WD based on a signal destined for the WD received from the CU. The generation of signals to be transmitted to each AP uses downlink channel characteristics between the WD and each AP in the cluster associated with the WD. Each AP in the cluster associated with the WD transmits a radio signal based on the signal received from the DU. The WD determines the signal received by the DU from the CU based on the radio signals received from each AP in the cluster associated with the WD. Similarly, in the uplink direction, the radio signal transmitted by the WD is received by each AP in the cluster associated with the WD and transmitted to the DU. The DU determines the signal transmitted by the WD based on the signals received from each AP in the cluster associated with the WD. Note that this determination uses uplink channel characteristics between the WD and each AP in the cluster associated with the WD. Thus, in CF-mMIMO, the DU is a unit that performs MIMO processing.

Note that PTL 2 also discloses a configuration for dynamically controlling APs included in the cluster of a WD.

### Citation List

### Patent Literature

PTL 1 : Japanese Patent Laid-Open No. 2020-136787

PTL 2 : Japanese Patent Laid-Open No. 2023-81600

By using a network virtualization technique, the CUs and DUs can be implemented not by dedicated hardware but by executing appropriate programs on general-purpose computers. In such a case, one or more computers (hereinafter referred to as a computer group or computer set) are deployed at edge sites and central sites, and the CUs and DUs are virtually implemented within each computer group.

FIG. 1 illustrates a configuration of a RAN when the network virtualization technique is used. A computer group 61 is deployed at a central site 41, and a computer group 62 is deployed at an edge site 42. The computer group 61 of the central site 41 is connected to each computer group 62 of a plurality of edge sites 42 via a transmission path 7. The transmission path 7 may be a wired transmission path or a wireless transmission path. In FIG. 1, the number of edge sites 42 accommodated by one central site 41 is shown as three by way of example, but the number of edge sites 42 accommodated by one central site 41 may be any number of two or more. In the following description, when distinguishing the three edge sites 42, they are referred to as Edge Site #1, Edge Site #2, and Edge Site #3 as shown in FIG. 1.

The computer group 62 of each edge site 42 is connected to each of a plurality of APs via a wired or wireless transmission path. In the following description, a plurality of APs connected to one computer group 62 are collectively referred to as an AP set 43. As shown in FIG. 1, the computer group 62 of each edge site 42 is connected to each AP of one AP set 43. In the following description, when distinguishing the three AP sets 43, they are referred to as AP Set #1, AP Set #2, and AP Set #3 as shown in FIG. 1. In FIG. 1, AP Set #1 is accommodated in Edge Site #1, AP Set #2 is accommodated in Edge Site #2, and AP Set #3 is accommodated in Edge Site #3. Note that the number of APs included in an AP set 43 may differ for each AP set 43.

FIG. 2 illustrates a state in which two WDs 5 are communicating using CF-mMIMO in the RAN configuration of FIG. 1. In the following description, when distinguishing the two WDs 5, they are referred to as WD #1 and WD #2 as shown in FIG. 2. In FIG. 2, the number of APs included in AP Set #1 accommodated by the computer group 62 of Edge Site #1 is shown as four. In the following description, when distinguishing these four APs, they are referred to as AP #1, AP #2, AP #3, and AP #4 as shown in FIG. 2.

In FIG. 2, the cluster of WD #1 includes AP #1, AP #2, and AP #3, and the cluster of WD #2 includes AP #3 and AP #4. For communication with WD #1, DU #1 is deployed in the computer group 62 of Edge Site #1, and CU #1 is deployed in the computer group 61 of the central site 41. Further, for communication with WD #2, DU #2 is deployed in the computer group 62 of Edge Site #1, and CU #2 is deployed in the computer group 61 of the central site 41. For example, DU #1 transmits signals to AP #1, AP #2, and AP #3 so that they can transmit radio signals to WD#1 based on a signal from CU #1 intended for WD #1. DU #1 also generates a signal transmitted by WD #1 based on signals received from AP #1, AP #2, and AP #3 and transmits it to CU #1. The same applies to WD #2.

In FIG. 2, lines connecting the APs and the DUs indicate signal paths between functions and do not represent transmission paths. For example, the downlink (DL) signal from DU #1 to AP #3 and the DL signal from DU #2 to AP #3 are transmitted via the same DL transmission path that transmits signals from the computer group 62 of Edge Site #1 to AP #3. Similarly, the uplink (UL) signal from AP #3 to DU #1 and the UL signal from AP #3 to DU #2 are transmitted via the same UL transmission path that transmits signals from AP #3 to the computer group 62 of Edge Site #1.

Furthermore, in FIG. 2, a line connecting CU #1 and DU #1 and a line connecting CU #2 and DU #2 indicate signal paths between functions and do not represent transmission paths. For example, the DL signal from CU #1 to DU #1 and the DL signal from CU #2 to DU #2 are transmitted via the same DL transmission path 7 that transmits signals from the computer group 61 of the central site to the computer group 62 of Edge Site #1. Similarly, the UL signal from DU #1 to CU #1 and the UL signal from DU #2 to CU #2 are transmitted via the same UL transmission path 7 that transmits signals from the computer group 62 of Edge Site #1 to the computer group 61 of the central site.

FIG. 3 illustrates a case where DU #2 accommodating WD #2 is moved from the state shown in FIG. 2 to the computer group 61 of the central site 41. As shown in FIG. 3, when DU #2 accommodating WD #2 is placed in the computer group 61 of the central site 41, the signals transmitted and received between DU #2 and AP #3 and between DU #2 and AP #4 are also transmitted via the transmission path 7 connecting the computer group 61 of the central site 41 and the computer group 62 of Edge Site #1. Generally, the transmission rate of DL signals from CU to DU and the transmission rate of DL signals from DU to AP are not the same, but the difference is not significant. Therefore, assuming that the transmission rate of DL signals from CU to DU and the transmission rate of DL signals from DU to AP are the same value S, in FIG. 2, the transmission rate of DL signals to WD #2 transmitted via transmission path 7 is S, whereas in FIG. 3, the transmission rate of DL signals to WD #2 transmitted via transmission path 7 becomes 2S. The same applies to the UL direction.

Thus, when a DU accommodating a WD 5 whose transmission rate is S and whose cluster includes N APs (where N is an integer of 2 or more) is placed in the central site 41, the transmission rate on the transmission path 7 connecting the central site 41 and the edge site 42 increases by (N − 1) × S compared to when the DU is placed in the edge site 42. Since the transmission path 7 has an upper limit on transmission rate, when determining the placement of the DUs, it is necessary to ensure that the total transmission rate on the transmission path 7 does not exceed the upper limit rate set for the transmission path 7. For example, placing all DUs in the edge site 42 can minimize the total transmission rate on the transmission path 7, but due to limitations in the computing resources of the computer group 62 of the edge site 42, it may not be possible to place all DUs in the edge site 42. In addition, as disclosed in PTL 1, depending on the type of communication by the WD 5, it may be preferable to place the DU in the central site 41.

### SUMMARY OF THE INVENTION

According to an aspect of the present disclosure, a control node for a radio access network, the radio access network comprising: a plurality of access points; a first computer group connected to the plurality of access points; and a second computer group connected to the first computer group via a transmission path, wherein, in the radio access network, a wireless device is associated with one or more access points of the plurality of access points and with a unit implemented on the first computer group or the second computer group by a virtualization technique, and the wireless device and the unit associated with the wireless device communicate via the one or more access points associated with the wireless device, the control node includes: a collection unit configured to collect rate information and number information of a wireless device for each of one or more wireless devices, wherein the rate information of the wireless device indicates a transmission rate between the unit associated with the wireless device and one of the one or more access points associated with the wireless device, and the number information of the wireless device indicates a number of the one or more access points associated with the wireless device, and a determination unit configured to determine, in a manner satisfying constraint conditions, whether to implement the unit associated with each of the one or more wireless devices on the first computer group or the second computer group, wherein the constraint conditions include a first condition that is satisfied when a total transmission rate of signals transmitted over the transmission path for communication with the one or more wireless devices does not exceed a maximum transmission rate set for the transmission path.

Other features and advantages of the present invention will become apparent from the following description with reference to the accompanying drawings. In the accompanying drawings, the same or similar components are denoted by the same reference numerals.

### BRIEF DESCRIPTION OF THE DRAWINGS

FIG. 1 is a configuration diagram of a RAN.

FIG. 2 is a diagram illustrating an example of communication using CF-mMIMO.

FIG. 3 is a diagram illustrating an example of communication using CF-mMIMO.

FIG. 4 is a diagram illustrating a control configuration of the RAN.

FIG. 5 is a flowchart according to some embodiments.

FIG. 6 is a flowchart according to some embodiments.

FIG. 7 is a configuration diagram of a control node according to some embodiments.

FIG. 8 is a configuration diagram of a control node according to some embodiments.

FIG. 9 is a configuration diagram of a DU according to some embodiments.

### DESCRIPTION OF THE EMBODIMENTS

The embodiments are described in detail below with reference to the accompanying drawings. The following embodiments do not limit the invention of the claims, and not all of the combinations of features described in the embodiments are essential to the invention. Two or more of the features described in the embodiments may be arbitrarily combined. The same reference number is used for the same or similar elements, and duplicated explanations are omitted.

### First Embodiment

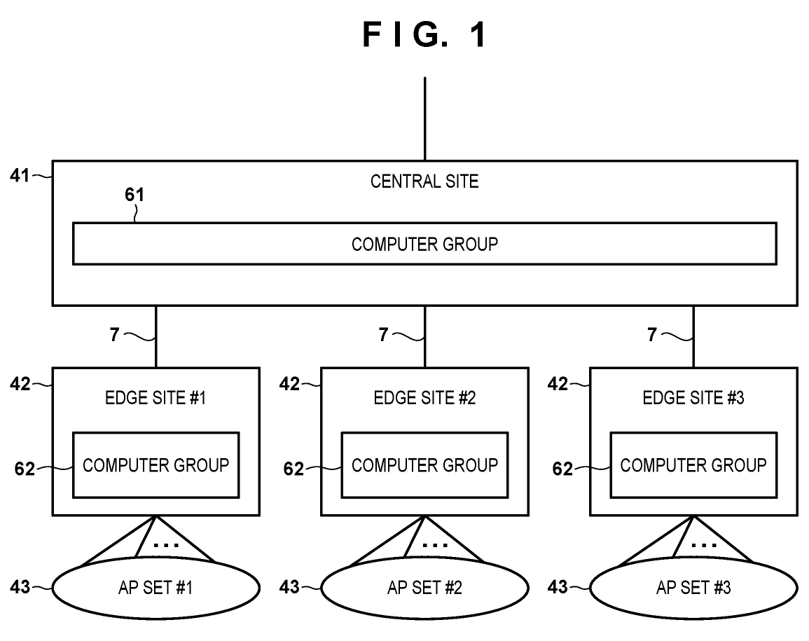

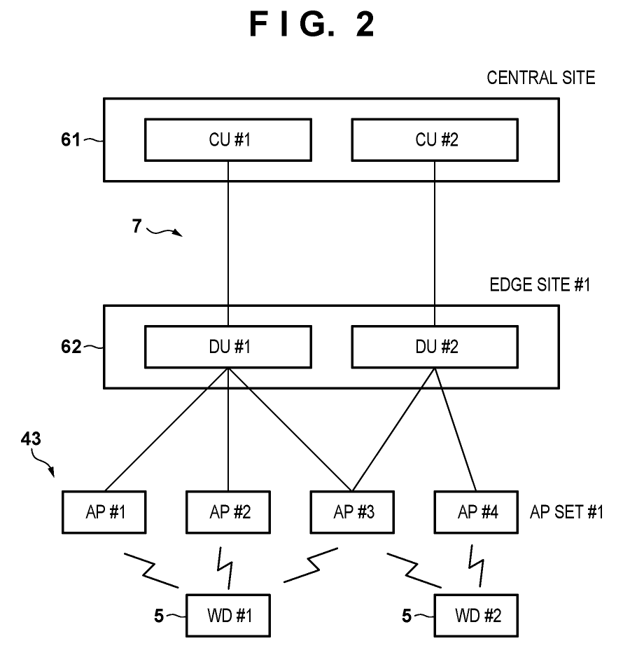

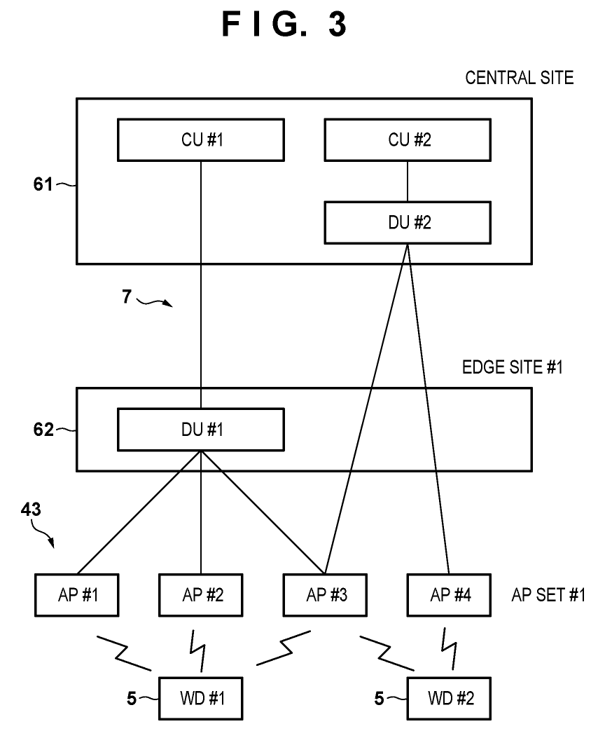

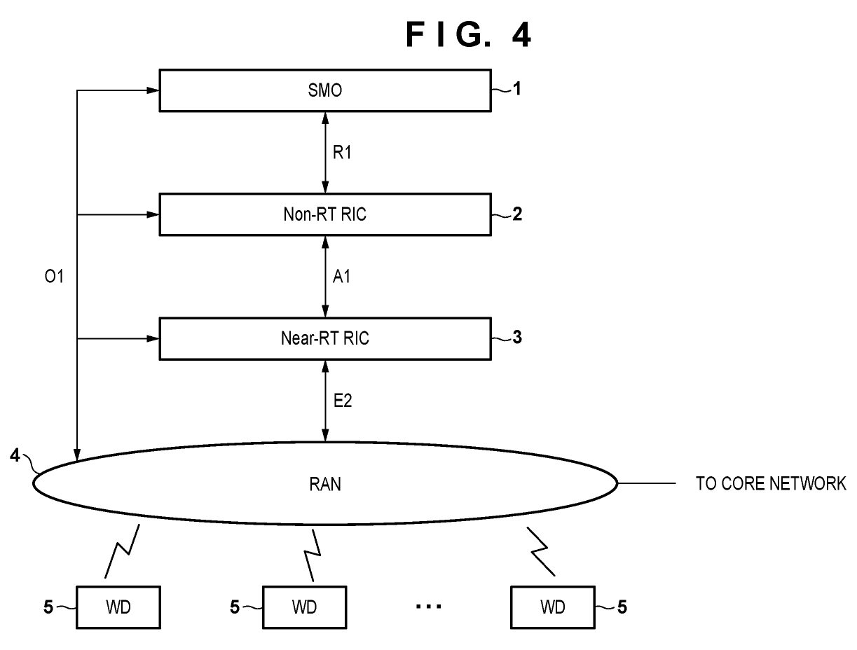

FIG. 4 is a control configuration diagram of a RAN 4 according to the present embodiment. The configuration of the RAN 4 is as shown in FIG. 1, and its description is omitted here. The configuration of FIG. 4 is based on the control architecture defined by Open Radio Access Network (O-RAN) ALLIANCE and includes a Service Management and Orchestration (SMO) 1, a Non-Real-Time RAN Intelligent Controller (Non-RT RIC) 2, and a Near-Real-Time RAN Intelligent Controller (Near-RT RIC) 3. The Near-RT RIC 3 performs short-term control, while the Non-RT RIC 2 performs control over a longer cycle than the Near-RT RIC 3.

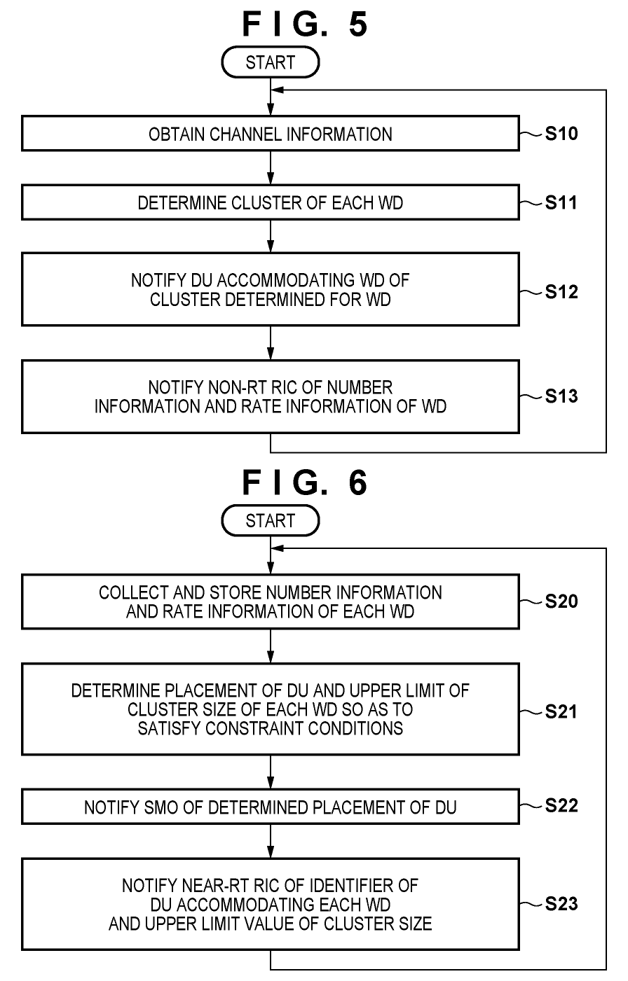

The interface between the Near-RT RIC 3 and the RAN 4 is referred to as the E2 interface. The interface between the Non-RT RIC 2 and the Near-RT RIC 3 is referred to as the A1 interface. Furthermore, the interface between the SMO 1 and the Non-RT RIC 2 is referred to as the R1 interface. In addition, O-RAN ALLIANCE defines the O1 interface that interconnects the SMO 1, Non-RT RIC 2, Near-RT RIC 3, and RAN 4. Although FIG. 4 shows only one Near-RT RIC 3, a Near-RT RIC 3 is provided for each sub-area obtained by dividing the geographic area covered by the RAN 4. In other words, a plurality of Near-RT RICs 3 may be connected to one Non-RT RIC 2 via the A1 interface. In this case, one Near-RT RIC 3 controls the components located within the corresponding sub-area of the RAN 4. In the present embodiment, the Near-RT RIC 3 determines the APs to be included in the cluster of the WD 5. FIG. 5 is a flowchart of the process executed by the Near-RT RIC 3. In S10, the Near-RT RIC 3 obtains channel information (channel characteristics) between the WD 5 and each AP from the RAN 4 via the E2 interface. In S11, based on the channel information obtained in S10, the Near-RT RIC 3 determines, for each WD 5, one or more APs to be included in the cluster of the WD 5, that is, determines the cluster of the WD 5. For example, the Near-RT RIC 3 may determine the cluster of the WD 5 so as to satisfy the quality of service (such as throughput or error rate) to be provided to the WD 5. If, as described later, the Non-RT RIC 2 has notified an upper limit value on the number of APs that can be included in the cluster of the WD 5, the Near-RT RIC 3 determines the cluster so that the number of APs included in the cluster does not exceed the notified upper limit value. In the following description, the term “cluster size” is used to refer to the number of APs in a cluster.

In S12, the Near-RT RIC 3 notifies the DU accommodating the WD 5 of the cluster determined for the WD 5 via the E2 interface. In S13, the Near-RT RIC 3 notifies the Non-RT RIC 2, via the A1 interface, of “number information” indicating the cluster size of each WD 5 and “rate information” indicating the DL and UL transmission rate S between the WD 5 and one AP in the cluster of the WD 5, for processing in the Non-RT RIC 2 described later. The Near-RT RIC 3 repeatedly executes the process of FIG. 5 according to the control cycle of the Near-RT RIC 3.

In the present embodiment, the Non-RT RIC 2 determines, for each WD 5, whether to place the DU accommodating the WD 5 in the computer group 61 of the central site 41 or in the computer group 62 of the edge site 42, and determines the upper limit value of the cluster size of each WD 5 so as to satisfy “constraint conditions.” In the present embodiment, the constraint conditions include a first constraint condition related to computing resources and a second constraint condition related to the transmission rate on the transmission path 7.

First, the first constraint condition will be described. The first constraint condition is that the total computing resources required for one or more DUs placed in one computer group 62 do not exceed the maximum computing resources available for DUs in the computer group 62. Therefore, the maximum computing resources available for DUs in each computer group 62 of each edge site 42 are preset in the Non-RT RIC 2. The maximum computing resources available for DUs may differ for each edge site 42. The Non-RT RIC 2 determines the DUs to be placed in the computer group 62 of each edge site 42 so that the total computing resources required for one or more DUs placed in the computer group 62 do not exceed the maximum computing resources available for DUs in the computer group 62.

Generally, the computing resources available for DUs in the computer group 61 of the central site 41 are sufficiently large, so in this embodiment, the computer group 61 of the central site 41 is not considered. However, the maximum computing resources available for DUs in the computer group 61 of the central site 41 may also be preset in the Non-RT RIC 2, and the configuration may ensure that the computing resources required for DUs placed in the computer group 61 do not exceed the computing resources available for DUs in the computer group 61.

Next, the second constraint condition will be described. The second constraint condition is that the sum of the transmission rates (hereinafter referred to as the total transmission rate) of signals for each WD 5 transmitted over the transmission path 7 must not exceed the upper limit value set for the transmission path 7. Therefore, the Non-RT RIC 2 uses the number information and rate information notified by the Near-RT RIC 3 in S13 of FIG. 5. Since the processing for the DL direction and the UL direction are similar, only the DL direction will be described below. The upper limit rate for the DL direction is preset in the Non-RT RIC 2 for each transmission path 7 connecting the central site 41 and the plurality of edge sites 42. The upper limit rate may differ for each edge site 42.

For example, assume that the rate information indicates that the transmission rate of a DL signal for a certain WD 5 is S and the number information indicates that the cluster size of the WD 5 is N. In this case, the Non-RT RIC 2 determines that if the DU accommodating the WD 5 is placed in the edge site, the total transmission rate on the transmission path 7 increases by S, and if the DU accommodating the WD 5 is placed in the central site, the total transmission rate on the transmission path 7 increases by S × N, and calculates the total transmission rate for all WDs 5 transmitted over the transmission path 7. Then, the Non-RT RIC 2 determines the placement of the DUs and the upper limit value of the cluster size of each WD 5 so that the total transmission rate does not exceed the upper limit rate of the transmission path 7.

As described above, since the transmission rate between the DU and the CU and the transmission rate between the DU and the AP are not exactly the same, the configuration may determine that if the DU accommodating the WD 5 is placed in the edge site, the total transmission rate on the DL transmission path 7 increases by S × α. Here, α is an adjustment coefficient preset in the Non-RT RIC 2. One DU performs processing for both the DL direction and the UL direction. Therefore, it is not possible to place the DU performing DL processing in the edge site 42 and the DU performing UL processing in the central site 41, or to place the DU performing UL processing in the edge site 42 and the DU performing DL processing in the central site 41. Thus, the placement of the DUs satisfying the second constraint condition must ensure that the total transmission rate does not exceed the upper limit rate in both the DL direction and the UL direction.

FIG. 6 is a flowchart of the process executed by the Non-RT RIC 2. The Non-RT RIC 2 repeatedly executes the process of FIG. 6 according to the control cycle of the Non-RT RIC 2. In S20, the Non-RT RIC 2 stores the number information and rate information of each WD 5 notified by the Near-RT RIC 3. In S21, the Non-RT RIC 2 determines the placement of the DUs and the upper limit value of the cluster size of each WD 5 so as to satisfy the “constraint conditions.” Since the control cycle of the Non-RT RIC 2 is longer than that of the Near-RT RIC 3, it is possible that the number information and rate information for the same WD 5 are received multiple times between the previous execution of S21 and the next execution of S21. In such a case, the Non-RT RIC 2 uses the latest number information and rate information for the WD 5 in the next S21.

In S22, the Non-RT RIC 2 notifies the SMO 1 of the determined placement of the DUs via the R1 interface. Note that each DU is assigned an identifier, and the Non-RT RIC 2 may indicate the placement of the DUs to the SMO 1 by specifying the DUs placed in each computer group 61 and 62 using their identifiers. The SMO 1 controls the computer group 61 of the central site 41 and the computer group 62 of the edge site 42 via the O1 interface so that the placement of the DUs becomes as notified.

In S23, the Non-RT RIC 2 notifies the Near-RT RIC 3, via the A1 interface, of the identifier of the DU accommodating each WD 5 and the upper limit value of the cluster size. By notifying the identifier of the DU accommodating the WD 5 to the Near-RT RIC 3, the DU accommodating the WD 5 may be changed from the edge site 42 to the central site 41 or changed from the central site 41 to the edge site 42. The Near-RT RIC 3 ensures that the cluster size determined for the WD 5 does not exceed the last notified upper limit value of the cluster size when determining the APs 43 to be included in the cluster of the WD 5.

Basically, the Non-RT RIC 2 places the DUs in the edge site 42, and if such placement does not satisfy the first constraint condition, the Non-RT RIC 2 may be configured to select a DU to move from the edge site 42 to the central site 41. In this case, the Non-RT RIC 2 may select the DU whose movement to the central site 41 results in the smallest increase in the total transmission rate on the transmission path 7.

If the type of communication service provided to the WD 5 requires that the DU accommodating the WD 5 be placed in the central site 41, the DU for the WD 5 may be placed in the central site 41. Furthermore, for example, in the configuration of FIG. 1, if the WD 5 is moving from the area of AP Set #1 to the area of AP Set #2, placing the DU accommodating the WD 5 in the central site 41 allows the cluster of the WD 5 to include APs from both AP Set #1 and AP Set #2, enabling the provision of necessary services to the WD 5 even when moving across edge sites 42. In such a case, the DU accommodating the WD 5 should also be placed in the central site 41. Thus, the configuration may consider placement constraints for the DU based on the type of communication service provided and the state of the WD 5 as a third constraint condition. The placement constraints for the DU based on the third constraint condition include a constraint that the DU should be placed in the central site 41 and a constraint that the DU should be placed in the edge site 42. In this case, if placing the remaining DUs in the edge site 42 after excluding the DUs whose placement is determined by the third constraint condition does not satisfy the second constraint condition, the Non-RT RIC 2 may select a DU, from the remaining DUs, to move to the central site 41.

The Non-RT RIC 2 may first determine whether to place the DU in the edge site 42 or the central site 41, and if the total transmission rate at that time is less than the upper limit rate but the difference is within a threshold, assign the cluster size of each WD 5 at that time as the upper limit of the cluster size for each WD 5. On the other hand, when the total transmission rate is lower than the upper limit rate and the difference exceeds the threshold, it is also possible to configure at least one WD 5 so that an upper limit greater than its cluster size is assigned to that WD 5. Furthermore, if none of the DU placement patterns satisfying the first constraint condition or both of the first and third constraint conditions satisfy the second constraint condition, the Non-RT RIC 2 may assign an upper limit value smaller than the current cluster size of at least one WD 5, that is, smaller than the cluster size determined by the Near-RT RIC 3, so as to satisfy the second constraint condition.

In S13 of FIG. 5, the Near-RT RIC 3 notifies the Non-RT RIC 2 of the number information and rate information of each WD 5. However, the configuration may be such that each DU implemented in the computer groups 61 and 62 repeatedly transmits the number information and rate information of the WDs 5 accommodated by the DU to the Non-RT RIC 2 via the O1 interface. In this case, S13 of FIG. 5 is omitted.

For example, if the computing resources of the computer group 62 are also sufficiently large, the configuration may be such that the first constraint condition is not considered. In this case, the Non-RT RIC 2 determines the placement of the DUs and the upper limit value of the cluster size of the WDs 5 so as to satisfy only the second constraint condition or to satisfy the second and third constraint conditions.

### Second Embodiment

Next, the second embodiment will be described, focusing on the differences from the first embodiment. In the first embodiment, the Near-RT RIC 3 determined the cluster of each WD 5. In the present embodiment, the cluster of each WD 5 is determined in the control-plane DU (DU-C). The DU-C controls one or more user-plane DUs (DU-U). The DU-U performs processing such as MIMO processing of signals from the CU to transmit signals to each AP in the cluster and MIMO processing of received signals from each AP in the cluster to determine signals to be transmitted to the CU. Therefore, in this embodiment, the flowchart of FIG. 5 represents the processing executed by the DU-C. In this case, S12 of FIG. 5 becomes the process of notifying the DU-U of the cluster of the WD. Also, for the notification in S13 of FIG. 5, the O1 interface is used. In addition, in the process of FIG. 6, the Near-RT RIC 3 is replaced with the DU-C. Furthermore, for the notification in S23 of FIG. 6, the O1 interface is used.

### Apparatus Configuration

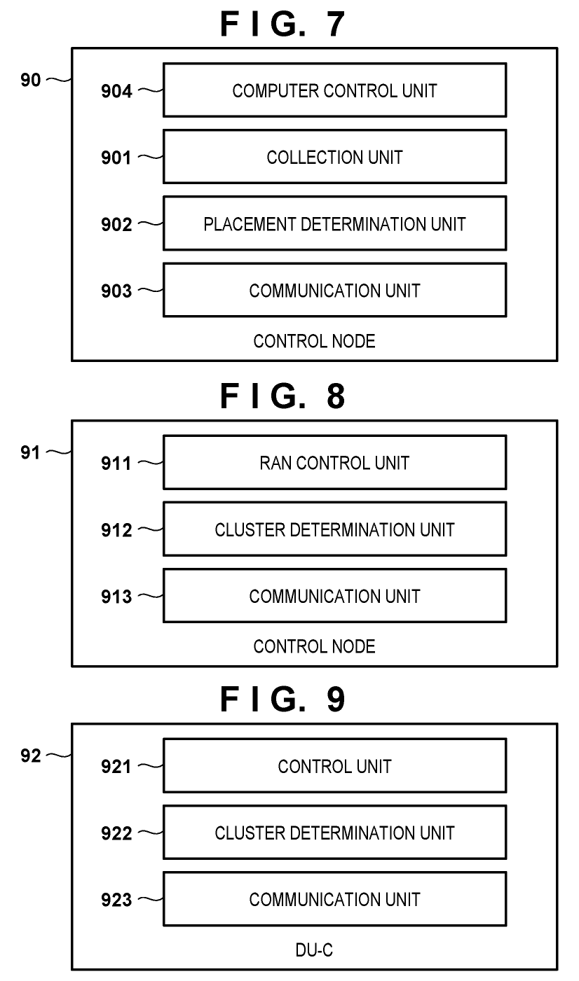

FIG. 7 is a configuration diagram of a control node 90 according to each embodiment. The control node 90 may be an apparatus that implements the functions of the Non-RT RIC 2 described in the embodiments above, or an apparatus that implements both the functions of Non-RT RIC 2 and SMO 1. A communication unit 903 provides the A1 interface, R1 interface, and O1 interface. A collection unit 901 collects number information and rate information of each WD 5 from the Near-RT RIC 3 or from computer groups 61 and 62. A placement determination unit 902 determines, so as to satisfy at least the second constraint condition, which of the computer groups 61 or 62 the DU that accommodates each WD 5 is placed in, and also determines the upper limit value of the cluster size for each WD.

A communication unit 903 notifies the Near-RT RIC 3, via the A1 interface, of the placement location of the DU accommodating each WD 5 and the upper limit value of the cluster size. Alternatively, the communication unit 903 notifies computer groups 61 and 62, via the O1 interface, of the placement location of the DU accommodating each WD 5 and the upper limit value of the cluster size. Further, when the SMO 1 is not included in the control node 90, the communication unit 903 notifies the SMO 1 of the DU placement pattern via the R1 interface.

When the SMO 1 is included in the control node 90, the control node 90 includes a computer control unit 904. In this case, the R1 interface becomes an internal interface between the placement determination unit 902 and the computer control unit 904. The computer control unit 904 controls computer groups 61 and 62 to implement the DU according to the DU placement pattern notified by the placement determination unit 902.

FIG. 8 is a configuration diagram of a control node 91 according to the present embodiment. The control node 91 may be an apparatus that implements the functions of the Near-RT RIC 3 in the above embodiments. A communication unit 913 provides the A1 interface, E2 interface, and O1 interface. A cluster determination unit 912 determines the cluster of the WD 5. A transmission unit of the communication unit 913 transmits the number information and rate information of the WD 5 to the Non-RT RIC 2 via the A1 interface. A RAN control unit 911 controls the RAN 4 via the E2 interface.

FIG. 9 is a configuration diagram of a DU-C 92 according to the present embodiment. A communication unit 923 provides the E2 interface and O1 interface. A cluster determination unit 922 determines the cluster of the WD 5. A transmission unit of the communication unit 923 transmits the number information and rate information of the WD 5 to the Non-RT RIC 2 via the O1 interface. A control unit 921 controls the DU-U. Note that FIG. 9 may also be regarded as a configuration diagram of the functions implemented in the computer groups 61 and 62.

The control nodes 90 and 91 according to the present disclosure may be configured by a plurality of apparatuses capable of communicating with each other via a network. Furthermore, the control nodes 90 and 91 may each be implemented by a computer program that, when executed by one or more processors of an apparatus, causes the apparatus to operate as the control node 90 or 91. Accordingly, the present disclosure provides a computer program that, when executed by one or more processors of an apparatus, causes the apparatus to operate as the control node 90 or 91, and a computer readable storage medium storing the computer program. In addition, the present disclosure provides a method described with respect to FIG. 5 and FIG. 6, a computer program for causing an apparatus having one or more processors to execute the method described with respect to FIG. 5 and FIG. 6, and a computer readable storage medium storing the computer program.

The present invention is not limited to the above embodiments, and various changes and modifications can be made within the spirit and scope of the present invention.

What is claimed is:

1. A control node for a radio access network, the radio access network comprising: a plurality of access points; a first computer group connected to the plurality of access points; and a second computer group connected to the first computer group via a transmission path, wherein, in the radio access network, a wireless device is associated with one or more access points of the plurality of access points and with a unit implemented on the first computer group or the second computer group by a virtualization technique, and the wireless device and the unit associated with the wireless device communicate via the one or more access points associated with the wireless device, the control node comprising:
a collection unit configured to collect rate information and number information of a wireless device for each of one or more wireless devices, wherein the rate information of the wireless device indicates a transmission rate between the unit associated with the wireless device and one of the one or more access points associated with the wireless device, and the number information of the wireless device indicates a number of the one or more access points associated with the wireless device, and
a determination unit configured to determine, in a manner satisfying constraint conditions, whether to implement the unit associated with each of the one or more wireless devices on the first computer group or the second computer group, wherein
the constraint conditions include a first condition that is satisfied when a total transmission rate of signals transmitted over the transmission path for communication with the one or more wireless devices does not exceed a maximum transmission rate set for the transmission path.

2. The control node according to claim 1, wherein the determination unit is further configured to:
when the unit associated with the wireless device is implemented on the first computer group, determine the transmission rate of a signal transmitted over the transmission path for communication with the wireless device based on the transmission rate indicated by the rate information of the wireless device, and
when the unit associated with the wireless device is implemented on the second computer group, determine the transmission rate of a signal transmitted over the transmission path for communication with the wireless device based on a product of the transmission rate indicated by the rate information of the wireless device and the number indicated by the number information of the wireless device.

3. The control node according to claim 1, wherein the determination unit is further configured to determine, for each of the one or more wireless devices, an upper limit value of the number of the one or more access points to be associated with the wireless device so as to satisfy the first condition.

4. The control node according to claim 3, wherein the unit is configured to determine the one or more access points to be associated with each of the one or more wireless devices in accordance with the upper limit value determined by the determination unit for each of the one or more wireless devices.

5. The control node according to claim 3, wherein the radio access network includes a first node configured to determine the one or more access points to be associated with each of the one or more wireless devices in accordance with the upper limit value determined by the determination unit for each of the one or more wireless devices.

6. The control node according to claim 5, wherein the first node is a Near-Real-Time RAN Intelligent Controller.

7. The control node according to claim 5, wherein the collection unit is further configured to collect the rate information and the number information from the first node.

8. The control node according to claim 1, wherein the collection unit is further configured to collect the rate information and the number information from the first computer group and the second computer group.

9. The control node according to claim 1, further comprising a control unit configured to control the first computer group and the second computer group to implement the unit on the first computer group and the second computer group in accordance with the determination by the determination unit.

10. The control node according to claim 1, wherein the constraint conditions include a second condition that is satisfied when computing resources required for one or more units implemented on the first computer group do not exceed computing resources available for the unit in the first computer group.

11. The control node according to claim 1, wherein the unit is a distributed unit.

12. The control node according to claim 1, wherein the control node is a Non-Real-Time RAN Intelligent Controller.

13. A non-transitory computer readable storage medium storing a computer program including instructions which, when executed by one or more processors of an apparatus for a radio access network, the radio access network comprising: a plurality of access points; a first computer group connected to the plurality of access points; and a second computer group connected to the first computer group via a transmission path, wherein, in the radio access network, a wireless device is associated with one or more access points of the plurality of access points and with a unit implemented on the first computer group or the second computer group by a virtualization technique, and the wireless device and the unit associated with the wireless device communicate via the one or more access points associated with the wireless device, cause the apparatus to function as:
a collection unit configured to collect rate information and number information of a wireless device for each of one or more wireless devices, wherein the rate information of the wireless device indicates a transmission rate between the unit associated with the wireless device and one of the one or more access points associated with the wireless device, and the number information of the wireless device indicates a number of the one or more access points associated with the wireless device, and
a determination unit configured to determine, in a manner satisfying constraint conditions, whether to implement the unit associated with each of the one or more wireless devices on the first computer group or the second computer group, wherein
the constraint conditions include a first condition that is satisfied when a total transmission rate of signals transmitted over the transmission path for communication with the one or more wireless devices does not exceed a maximum transmission rate set for the transmission path.
